(19) United States
(12) Patent Application Publication
(10) Pub. No.: US 2010/0223873 A1
(43) Pub. Date: Sep. 9, 2010

(54) ROOFING MATERIAL

(76) Inventor: Steven W. Russell, Fort Myers, FL (US)

Correspondence Address: Frederick W. Mau II, 1108 Royal Avenue, Royal Oak, MI, 48073, US

(21) Appl. No.: 12/715,421

(22) Filed: Mar. 2, 2010

Related U.S. Application Data
(60) Provisional application No. 61/157,221, filed on Mar. 4, 2009.

(51) Int. Cl. E04D 1/10; E04C 2/32; E04C 2/24; B29C 43/28

(52) U.S. Cl. 52/309.4; 52/783.11; 52/555; 156/243

(57) ABSTRACT

A roofing material having the appearance of decorative shingles and/or roofing tiles. The roofing material comprises a bulk polymeric foam material which includes additional structural support which provides increased strength and durability at the front surface of the roofing material. The roofing material includes a mesh material which is disposed near the front surface of the roofing material. The roofing material may additionally include a barrier layer which further protects the surface of the roofing material.

### CROSS REFERENCE TO RELATED APPLICATIONS

This application claims priority from U.S. Provisional Patent Application Ser. No. 61/157,221, filed Mar. 4, 2009, the entire content of which is incorporated herein by reference.

### FIELD OF THE INVENTION

The present invention generally relates to roofing materials. More particularly, the present invention relates to roofing materials having a shingle or tile appearance.

### BACKGROUND

Decorative shingles and roofing tiles are very popular roofing materials used on various types of buildings. Decorative shingles and roofing tiles may be formed from slate, wood, cement, clay and other rigid materials which provide form various types of shapes, colors and textures. Such materials, however, can be expensive and difficult to install. Materials such as cement, slate, and clay can be very heavy which can limit their application or require the use of additional structural support. Furthermore, wood materials, may degrade over time and require periodic replacement and or treatment. The decorative shingles and roofing tiles may also require specific types of installation which may further increase their cost. As such, there is a need in the art for roofing materials which provide the look of decorative shingles and roofing tiles while providing for simple and low cost installation.

### SUMMARY OF THE INVENTION

Disclosed herein, is a roofing material comprising a panel having the appearance of a plurality of roofing elements such as roofing tiles or shingles. The roofing tiles or shingles may have a wood, clay or slate appearance. The roofing panel comprises a bulk polymeric foam material and a mesh material at least partially disposed within the polymeric material. As such, the mesh material may be disposed in at least a portion of the polymeric material. The mesh material may be disposed within the polymeric foam material at a position between the midpoint and the front surface of the roofing material. The mesh material may be disposed proximate to the front surface of the roofing material. The mesh material is preferably disposed within 3 cm from the front surface of the roofing material. More preferably, the mesh material may be disposed within 2 cm from the front surface of the roofing material. Most preferably, the mesh material is disposed within 1 cm from the front surface of the roofing material.

The roofing material may further comprise a barrier layer. The barrier layer may be formed from a gel-based precursor material, a liquid based precursor material, or a powder based precursor material. The mesh material may be at least partially disposed within the barrier layer. The roofing material may also comprise a topcoat layer which may be applied on the barrier layer or the polymeric foam material.

The polymeric foam material may be comprised of polyurethane free rise foam. The polyurethane free rise foam may have a density in the range of 2 pounds per cubic feet to about 25 pounds per cubic feet. Preferably, the polyurethane free rise foam may have a density in the range of 8 pounds per cubic feet to about 14 pounds per cubic feet.

The mesh material may comprise metal, composite material, polymer material, fiberglass, or any combination thereof. Preferably, the mesh material comprises a polymer coated fiberglass material.

Also disclosed herein is a method for forming a roofing material in a mold. The method may comprise the steps of 1) placing a mesh material in the mold proximate to the inner surface of the mold cavity, 2) dispensing a polymeric foam precursor material into the mold cavity, 3) sealing the mold, 5) placing the mold into a press, and 6) removing the roofing material from the mold. The method may further comprise the step of applying a barrier precursor material to the inner surface of the cavity of the mold prior to placing the mesh material into the mold. The method may also comprise the step of applying a topcoat layer to the roofing material when removed from the mold.

### BRIEF DESCRIPTION OF THE DRAWINGS

FIG. 1, is a depiction of a roofing tile type roofing material in accordance with the present invention.

FIG. 2, is a depiction of a shingle type roofing material in accordance with the present invention.

FIG. 3, is a depiction of a roof of a building having a roofing material in accordance with the present invention installed thereon.

### DETAILED DESCRIPTION OF THE PREFERRED EMBODIMENTS OF THE INVENTION

In accordance with the present invention there is provided a roofing material having the appearance of a plurality of roofing elements. The roofing elements may be shingles, decorative shingles and/or roofing tiles. The roofing material provides for simple and low cost installation while providing superior strength and durability. Increased strength and durability of the roofing material further prevents damage to the material which may be caused from forceful contact with inanimate objects, wildlife or exposure to inclement weather.

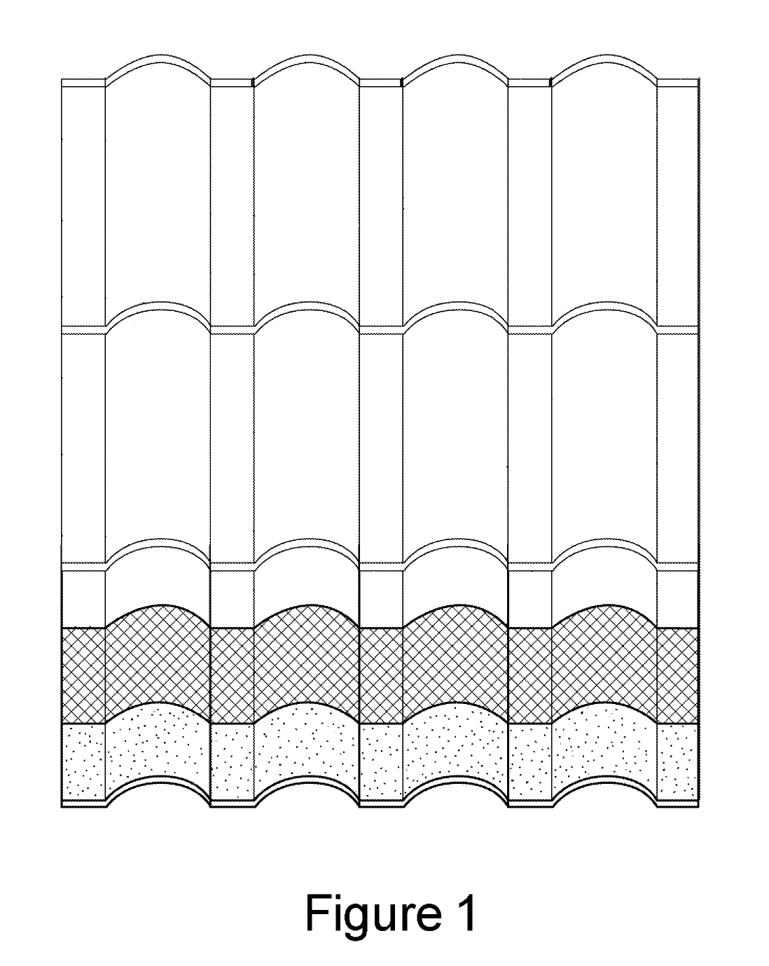

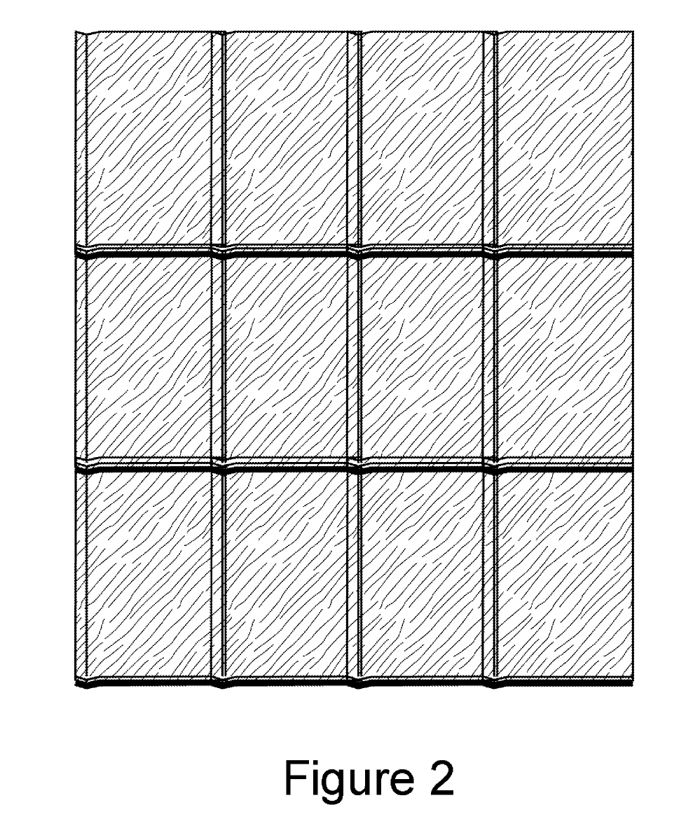

The roofing material generally comprises one or more panels, each panel having the appearance of a plurality of roofing tiles or shingles placed adjacent one another in one or more rows and/or one or more columns. The panels may be any shape or size depending on the desired application. For instance, the panel may be rectangular, triangular, circular, or any type polygonal shape. The panels of roofing material may have any desired color and texture. As shown in FIG. 1, the roofing material may comprise a panel having the appearance of a plurality of roofing tiles. The panel of FIG. 1 has the appearance of a plurality of barrel tiles having a wave-type shape, however, the panel may have the appearance of any type roofing tile. Such roofing tiles may have a wood, slate, or clay appearance. The roofing panel of FIG. 1 also has a cut-away view showing the mesh material disposed therein. Alternatively, the panel may have the appearance of a plurality of decorative shingles as shown in FIG. 2. The decorative shingles may have a wood or slate, or clay appearance.

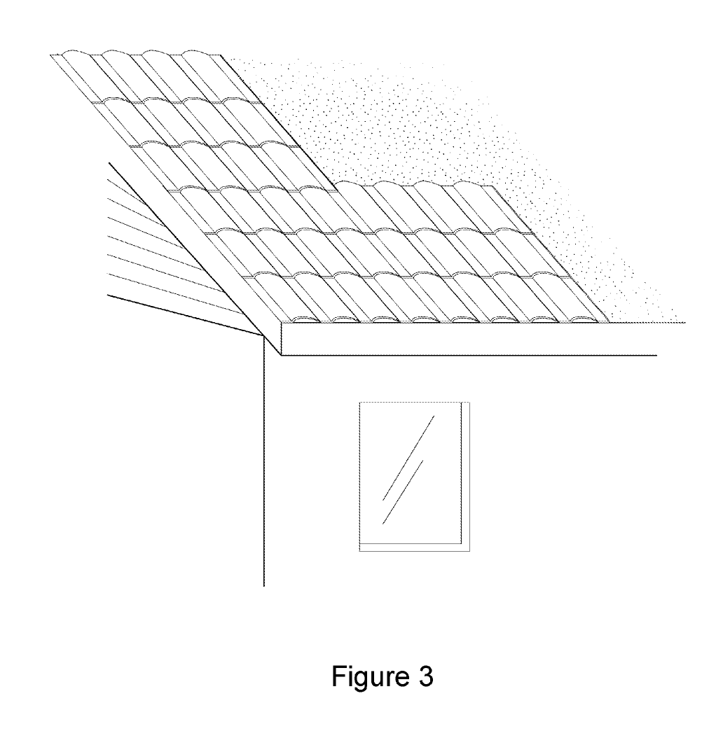

When installed onto the roof of a building, one or more panels may be placed adjacent to one another to cover the roof onto which the panels are placed as shown in FIG. 3. The sides of the panels may have a tongue and groove configuration which allows the panels to interconnect with one another. The panels may also interlock with one another whereby each side of a panel has a male or female portion which interlocks with the opposing male or female member on adjacent panels. One example of a male and female member is a hook which is adapted to fit into a slot. During the installation process, a sealant may be applied to the between the edges of the adjacent panels to seal the panels together and prevent moisture, insects, or debris from residing between or under the roofing panels.

The panels of roofing material may be attached to the roof of a building by any suitable installation method. Such methods may include adhesives/glue, nails, and bolts. The panels may also be designed such that they interlock with structures installed onto the roof of a building. To aid in attachment to the roof, the panels may be integrated with a substrate material. The substrate material may be placed upon or integrated into the back portion of the panel. The substrate material may be comprised of metal, such as stainless steel or aluminum, a polymeric material, a composite material or wood. The substrate material may provide additional rigidity to the panel. The substrate material may also allow the panels to be more easily attached to the roof by inclusion of installation points, such as apertures, or mounting structures, such as hooks or bolts, into the substrate material. Mounting structures within the substrate material may also allow the panels to interconnect with adjacent panels of roofing material.

The panels of roofing material comprise a bulk material layer and a mesh material. The bulk material layer comprises a high density polymeric foam material. The mesh material may be disposed within the bulk material layer. Preferably, the mesh material is disposed in the bulk layer at a position between the midpoint and the front surface of the roofing material. The midpoint of the roofing material is defined herein as a point within the roofing material that is halfway between the front surface of the roofing material and the portion of the back surface of the roofing material furthest from the front surface of the roofing material. The back surface of the roofing material is defined herein as the surface opposite the front surface of the roofing material. More preferably, the mesh material is disposed within the bulk material layer adjacent to the front surface of the roofing material. The mesh material being disposed adjacent to the front surface of the roofing material provides increased durability and strength to the front surface of the roofing material. Specifically, the mesh material may be disposed within 3 cm from the front surface of the roofing material. More preferably, the mesh material may be disposed within 2 cm from the front surface of the roofing material. Most preferably, the mesh material may be disposed within 1 cm from the front surface of the roofing material.

The roofing material may further comprise a barrier layer. The barrier layer may be a thin layer disposed on the front surface of the roofing material. The barrier layer is located adjacent to the bulk layer such that the barrier layer coats the surface of the bulk layer. The barrier layer may provide the color and appearance of the roofing material. The barrier layer may also protect the roofing material from weathering and/or fading. Alternatively to being disposed within the bulk layer, the mesh material may be disposed in the barrier layer or at the transition between the bulk layer and the barrier layer.

The bulk layer generally comprises a high density polymeric foam material. Examples of polymeric foam materials are polyurethane foam, polyethylene foam, and polystyrene foam. Polyurethane foam is the preferred material for the bulk layer of the roofing material. Polyurethane foam material has a fast cure rate which enables finished parts to be produced after cooling in two to fifteen minutes.

The polyurethane foam may be formed by mixing a first component A with a second component B. When mixed, component A and component B react exothermically to form a polyurethane foam. The final density of the polyurethane foam can be controlled by modifying the starting materials and/or modifying the amount of material placed into the mold. The polyurethane foam in the bulk layer may have a density in the range of 2 pounds per cubic feet to about 25 pounds per cubic feet. Preferably, the density of the polyurethane foam is in the range of 8 pounds per cubic feet to about 14 pounds per cubic feet.

The first component A is a resin component generally containing one or more polyols and the second component B is a material containing one or more isocyanate compounds. Component A and component B may be mixed in a ratio of 1:1 by volume. The ratio of component A to component B may vary from 1:10 to 10:1.

The first component A may comprise a polyether polyol blend. Examples of polyol compounds include any difunctional or polyfunctional hydroxyl compounds having a molecular weight below about 1800 such as, 1,2- and 1,3-propylene glycol; 1,4- and 2,3-butylene glycol; 1,6-hexane diol; 1,8-octane diol; neopentyl glycol; cyclohexane dimethanol (1,4-bis-hydroxy-methyl cyclohexane); 2-methyl-1,3-propane diol; glycerol; trimethylol propane; 1,2,6-hexane triol; 1,2,4-butane triol; trimethylolethane; pentaerythritol; quinitol; mannitol and sorbitol; methyl glycoside; diethylene glycol; triethylene glycol; tetraethylene glycol; polyethylene glycols; dipropylene glycol; dibutylene glycol and polybutylene glycols.

The first component A may additionally include one or more blowing agents and/or catalytic agents. Blowing agents may be used to tailor the cellular structure of the polyurethane foam. The catalytic agents may be used to help the reaction between component A and component B progress and/or aid the final curing process of the material. The first component may also include one or more structural additives which increase the rigidity and strength of the material. Such additives may include fiberglass, cementitious materials, and other type filler materials. To provide color and varied surfaces to the roofing material, colorants, dispersion dyes and pigments may be added to component A. To reduce ultraviolet oxidation and enhance weathering anti-oxidation and ultraviolet adsorber additives may also be included in component A.

The second component B may be an isocyanate material. In particular, the isocyanate material may be polymeric diphenylmethane diisocyanate. Examples of other conventional isocyanates that may be included in component B include organic aromatic and aliphatic polyisocyanates or mixtures thereof. Organic aromatic polyisocyanates for example may be 2,4-toluenediisocyanate, 2,6-toluenediisocyanate, p-phenylene diisocyanate, naphthalene diisocyanate, polymethylene polyphenyl isocyanates, 1,6-hexamethylene diisocyanate, 1,4-cyclohexyl diisocyanate, 1,4-bis isocyanoctomethyl-cyclohexane and mixtures thereof.

The mesh material may be any type mesh material formed from polymer materials, composite materials, fiberglass, metal, or any combination thereof. Preferably the mesh material is a polymer coated fiberglass mesh. An example of polymer coated fiberglass mesh is 921 Sto Armor Mat from Sto Corporation. Any size mesh may be used in accordance with the present invention. Preferably the size of the mesh is in the range of 0.0625 inches to 0.5 inches. More preferably, the size of the mesh is in the range of 0.125 to 0.25 inches. The mesh material may be flexible or rigid. The thickness of the mesh material may vary so as to provide the desired flexibility or rigidity of the mesh material. The thickness of the mesh material may be in the range of 0.0625 inches to 0.025 inches. Preferably, the mesh is able to conform to the shape of the front surface of the roofing material. The area of the mesh material is preferably approximate to the area of the front surface of the roofing material such that the mesh material and the front surface of the roofing material have similar lengths and widths. This allows the mesh material to be positioned along the entire length and width of the front surface of the roofing material.

The barrier layer is generally comprised of a protective coating which is applied onto the surface of the roofing material. The barrier layer may have a density higher than the bulk layer material. The barrier layer may be applied onto the inner surface of a mold prior to introduction of the bulk layer material into the mold. When applied onto the inner surface of the mold cavity, the precursor material is preferably fully cured before the bulk layer material is introduced into the mold cavity. Introducing the bulk material into the mold cavity when the barrier material is not fully cured may result in formation of weak area in the roofing material. The barrier layer may also be applied onto the surface of the roofing material upon removal from the mold.

The barrier layer may be formed from a precursor material in liquid or gel form. The gel or liquid precursor material may be water or solvent based. Once dry, the precursor gel or liquid material forms the barrier layer on the roofing material. The barrier layer may include pigments which provide the desired color to the roofing material. The barrier layer may also include additives which protect the roofing material from weathering and fading. An example of a gel-type material that may be utilized as the barrier layer is a modified wollastanite mineral fiber-reinforced polyester gel coat material. Such material is applied onto the surface of a mold and cured prior to addition of the polyurethane foam precursor components. An example of a liquid material is an acrylic barrier coating. A specific type of acrylic barrier coating may be WB White Barrier Coating as supplied from Berkley Products Company of Akron, Pa. Such materials may provide excellent chip resistance to the roofing material while providing an aesthetically appealing surface.

The barrier layer may also be formed from a powdered material. The powdered material may be applied to the mold cavity prior to introducing the bulk layer material into the mold. The powdered material may remain in powder form prior to the polyurethane material being introduced into the mold cavity. Alternatively, the powdered material may be wetted with water or solvent based liquid prior to the polyurethane material being introduced into the mold cavity to form a precursor material as previously described. When wetted, the precursor material is preferably allowed to cure prior to the bulk material being introduced to the mold cavity.

The roofing material may further include a top coat material. The topcoat is generally applied on top of the barrier coat. When a barrier layer is not used, the topcoat may be applied directly onto the bulk layer. The topcoat may be selected from any type of paint, either latex or oil based. Preferably, the topcoat is a latex based exterior grade paint. The topcoat may also be selected from any type of protective coatings.

A high density polyurethane foam roofing material in accordance with the present invention may be formed via a molding process. The mold cavity used in the molding process may be any type mold cavity typically used to cast polymeric foam materials. Preferably, the mold cavity is formed from a polymeric silicone material which has rigid structural support. Prior to a mixture of component A and component B being introduced into the mold cavity, the mold cavity may be treated with a mold release agent to aid in removal of the finished part from the mold.

When forming the roofing material, the mesh material is first placed into the mold cavity. If a barrier layer is included in the roofing material, a precursor barrier material may be applied onto the inner surface of the mold cavity prior to the mesh material being placed in the mold. The precursor barrier material may be cured, partially cured, or uncured prior to the mixture of component A and component B being introduced into the mold. To hold the mesh material in place and to ensure its placement proximate to the front surface of the roofing material, the mesh material may be adhered to the precursor barrier material, and/or held into place via one or more structural supports. The structural supports may be selected from pins, tacks, staples, clips, and the like.

Once the mesh material is placed in the mold, component A and component B are mixed and subsequently dispersed into a mold cavity where component A and component B react to form a high density polyurethane foam. Once component A, component B, and the mesh material are placed into the mold, the mold cavity is sealed such that the reaction product, the polyurethane foam, expands and completely fills the mold cavity. The sealed mold cavity may then be placed into a press to prevent the polyurethane foam from expanding beyond the mold cavity. The mold is retained in the press from two to fifteen minutes which allows the polyurethane foam to cure and cool.

The density of the polyurethane foam may additionally be controlled by varying the amount of component A and component B placed into the mold cavity. The reaction between component A and component B is exothermic which provides heat that may be used to help fuse the barrier layer with the bulk layer of the roofing material.

While there have been described what are believed to be the preferred embodiments of the present invention, those skilled in the art will recognize that other and further changes and modifications may be made thereto without departing from the spirit of the invention, and it is intended to claim all such changes and modifications as fall within the true scope of the invention.

1. A roofing material comprising:
a panel having the appearance of a plurality of roofing elements, said panel comprising a bulk polymeric foam material and a mesh material disposed in at least a portion of said polymeric material.

2. The roofing material according to claim 1, wherein said mesh material is disposed within said polymeric material at a position between the midpoint and the front surface of said roofing material.

3. The roofing material according to claim 2, wherein said mesh material is disposed adjacent to the front surface of said roofing material.

4. The roofing material according to claim 1, wherein said mesh material is disposed within 3 cm from the front surface of said roofing material.

5. The roofing material according to claim 1, wherein said mesh material is disposed within 2 cm from the front surface of said roofing material.

6. The roofing material according to claim 1, wherein said mesh material is disposed within 1 cm from the front surface of said roofing material.

7. The roofing material according to claim 1 further comprising a barrier layer.

8. The roofing material according to claim 7, wherein said barrier layer is formed from a gel-based precursor material, a liquid based precursor material, or a powder based precursor material.

9. The roofing material according to claim 1, wherein said polymeric foam material is polyurethane free rise foam.

10. The roofing material according to claim 9, wherein said polyurethane free rise foam has a density in the range of 2 pounds per cubic feet to about 25 pounds per cubic feet.

11. The roofing material according to claim 9, wherein said polyurethane free rise foam has a density in the range of 8 pounds per cubic feet to about 14 pounds per cubic feet.

12. The roofing material according to claim 1, wherein said mesh material comprises metal, composite material, polymer material, fiberglass, or combinations thereof.

13. The roofing material according to claim 1, wherein said mesh material comprises a polymer coated fiberglass material

14. The roofing material according to claim 1, wherein said roofing material further comprises a topcoat layer.

15. The roofing material according to claim 1, wherein said panel has the appearance of a plurality of roofing tiles.

16. The roofing material according to claim 1, wherein said panel has the appearance of a plurality of shingles.

17. A method for forming a roofing material comprising the steps of:
1) applying a barrier precursor material to the inner surface of the cavity of a mold;
2) placing a mesh material in said mold proximate to the inner surface of the cavity of the mold;
3) dispensing a polymeric foam precursor material into the cavity of said mold;
4) sealing said mold;
5) placing said mold into a press;
6) removing said roofing material from said mold.

18. The method according to claim 17 further comprising the step of:
7) applying a topcoat layer to said roofing material.

19. A method for forming an roofing material comprising the steps of:
1) placing a mesh material in a mold proximate to the inner surface of the cavity of said mold;
2) dispensing a polymeric foam precursor material into the cavity of said mold;
3) sealing said mold;
4) placing said mold into a press;
5) removing said roofing material from said mold.

20. The method according to claim 19 further comprising the step of:
6) applying a topcoat layer to said roofing material.
